(19) United States
(12) Patent Application Publication
(10) Pub. No.: US 2008/0010614 A1
(43) Pub. Date: Jan. 10, 2008

(54) MOBILE COMMUNICATION TERMINAL AND METHOD FOR SETTING SLIDE ATTRIBUTE THEREOF

(76) Inventor: Sangkook LEE, Seoul (KR)

Correspondence Address: BIRCH STEWART KOLASCH & BIRCH, PO BOX 747, FALLS CHURCH, VA, 22040-0747, US

(21) Appl. No.: 11/766,645

(22) Filed: Jun. 21, 2007

(30) Foreign Application Priority Data
Jul. 4, 2006 (KR) 10-2006-0062461

(51) Int. Cl. G06F 3/048

(52) U.S. Cl. 715/843

(57) ABSTRACT

A method and terminal for setting slide attributes of a message, are provided. According to an embodiment, the method includes selecting a slide attribute setup menu for setting an attribute of at least one slide included in the message, and displaying a slide attribute setup screen including a slide selection window for selecting a slide number and an attribute setup window for setting the attribute of the slide that corresponds to the selected slide number.

### CROSS-REFERENCE TO RELATED APPLICATION

This non-provisional application claims priority under 35 U.S.C § 119(a) to Korean Patent Application No. 10-2006-0062461 filed in Korea on Jul. 4, 2006, the entire contents of which are hereby incorporated by reference.

### BACKGROUND OF THE INVENTION

1. Field of the Invention

The present invention relates to a mobile communication terminal and a corresponding method for setting slide attributes.

2. Description of the Background Art

The Multimedia Messaging Service (MMS) is a messaging service that users use to send and receive multimedia information. That is, multimedia messages include text, audio, images, and other data. For example, a user may create a multimedia message such as a slide show including slides with text, images and music, for example.

The user can then send the created slide show to another user, or may simply view the slide show on his or her own terminal. To create a slide show, the user first creates a plurality of different slides, each slide including text data, image data, audio data or any combination thereof as desired by the user. A typical multimedia message includes approximately ten slides, for example.

In addition, the user may view the slideshow they created by selecting a “view slide show” or “Replay Slide Show” menu option on the terminal. However, it is difficult for the user to change individual characteristics of each individual slide in the slide show. For example, the slides are presented for a particular duration, which is the same for each slide. The background and text color are also the same for each slide. Thus, it is difficult for the user to change certain characteristics related to viewing or replaying the created slide show.

### SUMMARY OF THE INVENTION

Accordingly, one object of the present invention is to address the above-noted and other problems.

Another object of the present invention is to provide a mobile communication terminal and corresponding method that allows a user to conveniently set slide attributes.

To achieve these and other advantages and in accordance with the purpose of the present invention, as embodied and broadly described herein, the present invention provides in one aspect a method for setting slide attributes including selecting a slide attribute setup menu for setting an attribute of at least one slide, and displaying a slide attribute setup screen including a slide selection window for selecting a slide number and an attribute setup window for setting the attribute of the slide that corresponds to the selected slide number. The present invention also provides a corresponding mobile terminal.

In another aspect, the present invention provides a method of processing a multimedia message including displaying a slide creation window to create at least one slide including multimedia data, displaying an attribute option for allowing attributes of the created at least one slide to be set or changed, and displaying an attribute selection window for allowing the attributes of the created at least one slide to be set or changed when the attribute option is selected. Further, the attribute selection window includes at least a duration option for setting a duration the created at least one slide is to be displayed in a slide show, and a color option for setting a color of the created at least one slide. The present invention also provides a corresponding mobile terminal.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a multimedia messaging service system according to an embodiment of the present invention;

FIG. 2 is a block diagram illustrating a mobile communication terminal according to an embodiment of the present invention;

FIG. 3 is a flow chart illustrating a method for setting attributes of multimedia messages according to an embodiment of the present invention; and

FIGS. 4A to 4D show different menu screens for setting attributes of multimedia messages according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

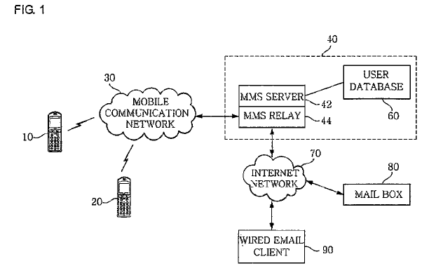

Turning first to FIG. 1, which is a block diagram illustrating a Multimedia Messaging Service (MMS) system according to an embodiment of the present invention. As shown, the MMS system includes one or more mobile communication terminals 10 and 20 connected to an MMS center 40 via a mobile communication network 30. The mobile terminals 10 and 20 may be a cellular phone, a Personal Communication System (PCS), a Personal Data Assistant (PDA), an International Mobile Communication-2000 (IMT 2000) phone, and so on.

Further, the mobile communication network 30 may be a Global System for Mobile (GSM) communication network, a Universal Mobile Telecommunications System (UMTS) network, a General Packet Radio Service (GPRS) network, a wireless RAN network, etc. Also, as shown in FIG. 1, the MMS system includes an external server such as a mail box 80, and a wired email client 90 connected to the MMS center 40 via an Internet network 70. In addition, the mail box 80 stores different messages, and the wired email client 90 is used to convey emails messages included on a wire network (i.e., from the wired network to the MMS center 40 via the Internet network 70).

Further, as shown in FIG. 1, the MMS center 40 includes an MMS server 42, an MMS relay 44 and a user database 60. In more detail, the MMS server 42 processes and stores MMS messages, the MMS relay 44 transfers messages form one message system to another message system, and the user database 60 stores user information such as a user's subscriber information and address information.

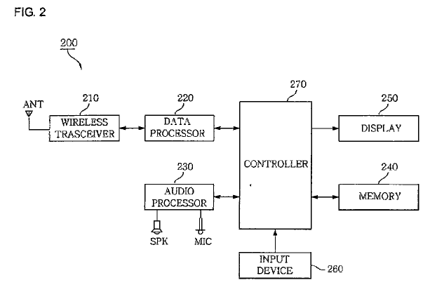

Next FIG. 2 is a block diagram illustrating a mobile communication terminal 200 according to an embodiment of the present invention. As shown, the mobile communication terminal 200 includes a wireless transceiver 210, a data processor 220, an audio processor 230, a memory 240, a display 250, an input device 260 and a controller 270.

In more detail, the wireless transceiver 210 performs a communication function for the mobile communication terminal 200 and includes an RF transmitter for up-converting and amplifying a transmitting signal and a RF receiver for low-noise amplifying and down-converting a frequency of a received signal. The data processor 220 includes a coder and modulator for respectively encoding and modulating the transmitting signal and a decoder and demodulator for respectively decoding and demodulating the receiving signal.

Further, the audio processor 230 sends an audio signal produced from a microphone (MIC) to the data processor 220, or reproduces an audio signal that is decoded and outputted from the data processor 220. In addition, the memory 240 includes a program memory and a data memory. That is, the program memory stores programs for controlling an operation of the mobile terminal 200, and stores a software program for executing a Multimedia Messaging Service (MMS).

Also, the display 250 outputs various display information and menu screens and may be a Liquid Crystal Display (LCD) or an Organic Light Emitting Diode (OLED) display. In more detail, the display 250 displays a multimedia message creating screen, an option menu screen, and a menu screen for setting slide attributes under the control of the controller 270.

Further, the input device 260 includes Various types of buttons for inputting numeral and character information as well as one or more function buttons for setting various types of functions. The input device 260 may be implemented with a key pad having a directional key, a jog-dial, a touch screen, a joystick, etc.

Further, according to the present invention, the input device 260 sends a user's request for setting the slide attributes to the controller 270. The controller 270 then controls the mobile terminal 200 based on the input from the user, thereby allowing the user to selectively change different characters of a multimedia message. For example, if the user wants to change the slide attributes such as the duration, the text color or the background color, the user can change these feature using the input device 260 and then the controller 270 appropriately changes the attributes as requested by the user. The controller 270 is also responsible for the overall operation of the terminal 200. Further, the controller 270 may be separate from the data processor 220 or the data processor 220 may be integrated together with the controller 270.

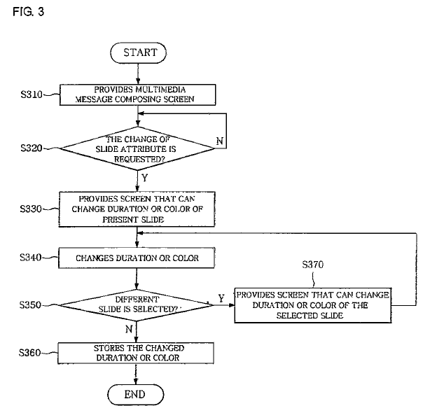

Turning next to FIG. 3, which is a flow chart illustrating a method for setting attributes of multimedia messages according to an embodiment of the present invention FIG. 2 will also be referred to in this description. As shown in FIG. 3, if the user wants to create or author a multimedia message, the controller 270 controls the display 250 to display a multimedia message authoring screen (S310). The user may request this screen by selecting an appropriate input button, key, display option, etc. provided on the terminal. The user is then able to create a multimedia message such as a slide show including a plurality of different multimedia slides. The method then determines if the user wants to change a slide attribute (S320).

In addition, if the user wants to change a particular attribute or attributes on a slide he or she is creating, the user can select an option menu provided on the slide or other preset option. When the user selects the option menu indicating he or she wants to change an attribute of the slide (Yes in S320), the controller 270 controls the display 250 to display an attribute setup screen of the present slide (S330). That is, the display displays a slide attribute setup screen that allows the user to change the duration or color of the present slide.

Further, the duration is a parameter that represents a replay time or a display time of the slide. The color of the slide includes a text color input to a corresponding slide and a background color of the corresponding slide. Therefore, as shown in FIG. 3, the user can change the duration or the color of the corresponding slide in the slide attribute setup screen (S340). The user can also select another slide that he or she wants to change attributes using the slide attribute setup screen (S350).

If the user selects a different slide in the slide attribute setup screen (Yes in S350), the user can then change the duration or the color of the selected slide using the slide attribute setup screen (S370). If the user does not select another slide (No in S350), the changed duration value or color value of the slide is stored in the memory 240. Therefore, the duration or color of the corresponding slide is changed to a value set by the user under the control of the controller 270. In other words, the controller 270 changes the duration or color defined in a Synchronized Multimedia Integration Language (SMIL) file, which includes the details about how to play or replay each slide.

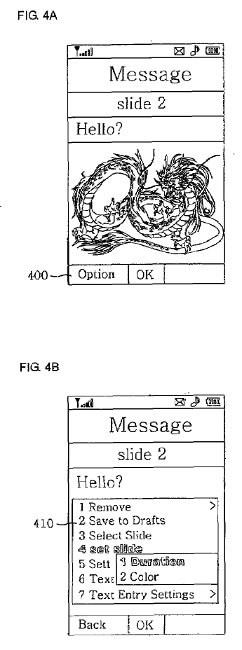

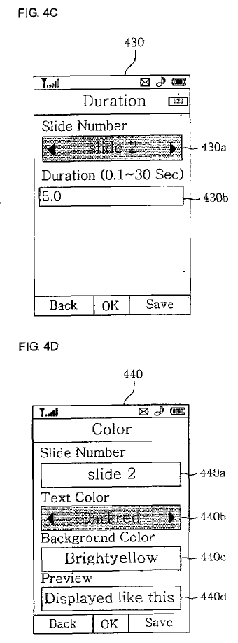

Next, FIGS. 4A to 4D show different examples of menu screens that can be used to change attributes of one or more slides, etc. according to an embodiment of the present invention. In more detail, as shown in FIG. 4A, a multimedia file such as a slide can contain text images, moving pictures and audio. In the example of FIG. 4A, the user has created a slide #2 include text and an image of a dragon.

Thus, if the user wants to change one or more attributes of the present slide, the user can simply select the Menu Option 400 in FIG. 4A. Then, the controller 270 controls the display 250 to display the menu screen 410 shown in FIG. 4B. As shown in FIG. 4B, the menu screen 410 includes several options such as 1) removing the present slide, 2) saving the present slide, 3) selecting all features on the slide, 4) setting the slide attributes, etc.

Thus, to change attributes of the present slide the user is currently creating, the user can select the menu item No. 4 “set slide” that will allow him or her to change the attribute of the slide. In more detail, as shown in FIG. 4B, when the user selects the menu item No. 4 “set slide,” another window is displayed (such as a pop-up window) allowing the user to set 1) the duration and/or 2) the color of the slide.

If the user selects the menu item No. 1 “Duration,” the controller 270 controls the display 250 to display a duration setup screen 430 as shown in FIG. 4C. As shown in FIG. 4C, the duration setup screen includes an input window 430b for setting a time duration of the slide and a selection window 430a for selecting the slide (i.e., the slide 2 in this example). Accordingly, the user can select the slide and set the duration using the duration setup screen. As a result, the duration of each slide can be set by one process.

Meanwhile, if the user selects the menu item No. 2 “Color” in FIG. 4B to change a color of the corresponding slide, the controller 270 controls the display 250 to display a color setup screen 440 as shown in FIG. 4D. As shown in FIG. 4D, the color setup screen 440 includes a selection window 440a for selecting the slide, a text color setup window 440b for setting the color of a text input or to be inputted to the slide, a background color setup window 440c for setting a background color of the slide, and a preview window 440d for previously checking the text color and the background color.

Thus, using this display screen 440, the user can select the slide and set the text color and the background color. Accordingly, the text color and the background color for each slide can be set in one process. Further, the above description described the slides attributes as relating to the text color and the background color. However, other attributes including those set forth in the SMIL file may also be set such the size of the text, etc.

Thus, the mobile communication terminal and corresponding method for setting the slide attributes of the multimedia messages produce the following advantage. That is, the user can change the duration and the color of each slide while creating multimedia messages with only a few input operations.

According to the above described embodiments, the slide including the multimedia message is used as an example. Other embodiments using a plurality of slides such as a photo slide show may be implemented without departing from the scope of the following claims.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for setting slide attributes, comprising:
selecting a slide attribute setup menu for setting an attribute of at least one slide; and
displaying a slide attribute setup screen including a slide selection window for selecting a slide number and a slide attribute setup window for setting the attribute of the slide that corresponds to the selected slide number.

2. The method of claim 1, further comprising:
If the attribute of a specific slide is set, displaying a preview screen for checking the specific data.

3. The method of claim 1, wherein the slide attribute setup menu includes a duration setup menu option for setting an amount of time the slide is displayed, and a color setup menu option for setting a color of the slide.

4. The method of claim 3 wherein when the color setup menu option is selected, the method further comprises displaying a text color setup window for setting a text color of the slide, a background color setup window for setting a background color of the slide, and a preview window for checking previously the text color and the background color.

5. The method of claim 3, wherein when the duration setup menu option is selected, the method further comprises displaying a duration setup window including an option for selecting a particular slide number and an option for setting the amount of time the particular slide number is displayed in a slide show.

6. The method of claim 1, wherein when a specific slide number is selected using the slide selection window and the slide attribute is set using the slide attribute setup window, the attribute is set for the slide corresponding to the selected slide number.

7. The method of claim 1, wherein the slide attribute setup menu is selected from a current slide a user is creating.

8. A mobile terminal for setting slide attributes, comprising:
a display unit configured to display an input page for creating a plurality of slides;
an input device configured to select a slide attribute setup menu for setting an attribute of at least one slide; and
a controller configured to control the display unit to display a slide attribute setup screen including a slide selection window for selecting a slide number and to display a slide attribute setup window for setting the attribute of the slide that corresponds to the selected slide number.

9. The terminal of claim 8, wherein the slide attribute setup menu includes a duration setup menu option for setting an amount of time the slide is displayed, and a color setup menu option for setting a color of the slide.

10. The terminal of claim 9, wherein when the color setup menu option is selected, the controller controls the display unit to display a text color setup window for setting a text color of the slide, to display a background color setup window for setting a background color of the slide, and to display a preview window for checking previously the text color and the background color.

11. The terminal of claim 9, wherein when the duration setup menu option is selected, the controller controls the display unit to display a duration setup window including an option for selecting a particular slide number and an option for setting the amount of time the particular slide number is displayed in a slide show.

12. The terminal of claim 8, wherein when a specific slide number is selected using the slide selection window and the slide attribute is set using the slide attribute setup window, the controller sets the attribute for the slide corresponding to the selected slide number.

13. The terminal of claim 8, wherein the slide attribute setup menu is selected from a current slide a user is creating.

14. A method of processing a multimedia message, comprising:
displaying a slide creation window to create at least one slide including multimedia data;
displaying an attribute option for allowing attributes of the created at least one slide to be set or changed; and
displaying an attribute selection window for allowing the attributes of the created at least one slide to be set or changed when the attribute option is selected,
wherein the attribute selection window includes at least a duration option for setting a duration the created at least one slide is to be displayed in a slide show, and a color option for setting a color of the created at least one slide.

15. The method of claim 14, further comprising:
displaying a duration selection window including an option for setting the duration the created at least one slide is to be displayed in the slide show, when the duration option is selected; and
displaying a color selection window including an option for setting the color of the created at least one slide, when the color option is selected.

16. The method of claim 15, wherein the duration selection window and the color selection window further include an option for selecting a particular slide among the created at least one slide in which the duration and color is to be set or changed.

17. The method of claim 15, wherein the color selection window includes an option for selecting a color of a text and background displayed in the created at least one slide.

18. The method of claim 14, wherein the attribute option is displayed on the slide creation window.

19. A mobile terminal for processing a multimedia message, comprising:
a display unit configured to display information; and
a control unit configured to control the display unit to display a slide creation window to create at least one slide including multimedia data, to display an attribute option for allowing attributes of the created at least slide to be set or changed, and to display an attribute selection window for allowing the attributes of the created at least one slide to be set or changed when the attribute option is selected,
wherein the attribute selection window includes at least a duration option for setting a duration the created at least one slide is to be displayed in a slide show, and a color option for setting a color of the created at least one slide.

20. The terminal of claim 19, wherein the control controls the display unit to display a duration selection window including an option for setting the duration the created at least one slide is to be displayed in the slide show, when the duration option is selected, and to display a color selection window including an option for setting the color of the created at least one slide, when the color option is selected.

21. The terminal of claim 20, wherein the duration selection window and the color selection window further include an option for selecting a particular slide among the created at least one slide in which the duration and color is to be set or changed,
wherein the color selection window includes an option for selecting a color of a text and background displayed in the created at least one slide, and
wherein the attribute option is displayed on the slide creation window.
